(19) United States
(12) Patent Application Publication
(10) Pub. No.: US 2009/0213041 A1
(43) Pub. Date: Aug. 27, 2009

(54) Solar backlight for transmissive displays

(76) Inventors: Robert Allan Unger, El Cajon, CA (US); Jean-Pierre Guillou, San Diego, CA (US)

Correspondence Address: MILLER PATENT SERVICES, 2500 DOCKERY LANE, RALEIGH, NC, 27606, US

(21) Appl. No.: 12/288,400

(22) Filed: Oct. 20, 2008

Related U.S. Application Data
(60) Provisional application No. 61/066,608, filed on Feb. 21, 2008.

(51) Int. Cl. G09G 3/18

(52) U.S. Cl. 345/52

(57) ABSTRACT

A backlighted electronic transmissive display assembly consistent with certain implementations has an electronic transmissive display panel that produces a visual display using light passing through the panel. A solar light collector collects sunlight. Light is received from the solar light collector and supplied as a backlight to the electronic transmissive display panel. This abstract is not to be considered limiting, since other embodiments may deviate from the features described in this abstract.

### CROSS REFERENCE TO RELATED DOCUMENTS

This application is related and claims priority benefit of U.S. Provisional Patent Application No. 61/066,608 filed Feb. 21, 2008 which is hereby incorporated herein by reference. This application is also related to an electronic publication by inventor and author Robert Unger entitled “Solar Backlight for Transmissive Displays” published electronically on Apr. 22, 2008, IP.COM publication number IPCOM000169560D.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Power consumption is a significant concern for displays, and particularly for electronic transmissive displays (e.g., liquid crystal displays (LCDs)) which use a source of backlight to produce a visible display image on the front of the panel. It is not uncommon for the backlight to exceed half of the total power consumed by such a display. Many such displays only allow approximately five percent of the backlight to pass through the display panel, thereby requiring a substantial amount of backlight in order for the display's brightness to approach that of the ambient environment in order for the display to be clearly visible. Additionally, in a brightly lighted environment even very bright conventional backlights may be inadequate to approach the ambient light environment, rendering such displays impractical.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example illustration of a solar backlighted electronic transmissive display panel consistent with certain embodiments of the present invention.

FIG. 2 is an example illustration of a solar backlighted electronic transmissive display panel consistent with certain embodiments of the present invention.

FIG. 3 is an example illustration of a solar backlighted electronic transmissive display panel consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment”, “an implementation”, “an example” or similar terms means that a particular feature, structure, or characteristic described in connection with the embodiment, implementation or example is included in at least one embodiment of the present invention. Thus, the appearances of such phrases or in various places throughout this specification are not necessarily all referring to the same embodiment, implementation or example. Furthermore, the particular features, structures, or characteristics may be combined in any suitable manner in one or more embodiments, implementations or examples without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Conventional electronic transmissive displays use artificial sources of light to create backlight illumination for the display. In accord with certain implementations consistent with the present invention, implementation and support technology are provided to permit use of sunlight as backlight illumination for LCD and similar panels. This enables large panels to be used for static picture displays or even dynamic picture displays without significant energy consumption.

In accord with certain implementations, light is ducted from the sun as the principle source for backlight illumination. The basic concept is shown in the FIG. 1 for an example interior application. Light is gathered by a roof mounted collector or outside collector (such as the exterior portion of such collectors commonly referred to as a solar tube 20 (e.g., a Solatube™ from Solatube International, Inc., Vista, Calif.) and then ducted into the wall 24 (or other cavity behind display panel). This ducting can be performed with a product such as a Solatube or a fiber optic bundle or any other suitable carrier of light. Light is then directed by the structure 30 (illustrated as a reflective structure) into the back surface of a electronic transmissive display panel 34 such as an LCD display panel.

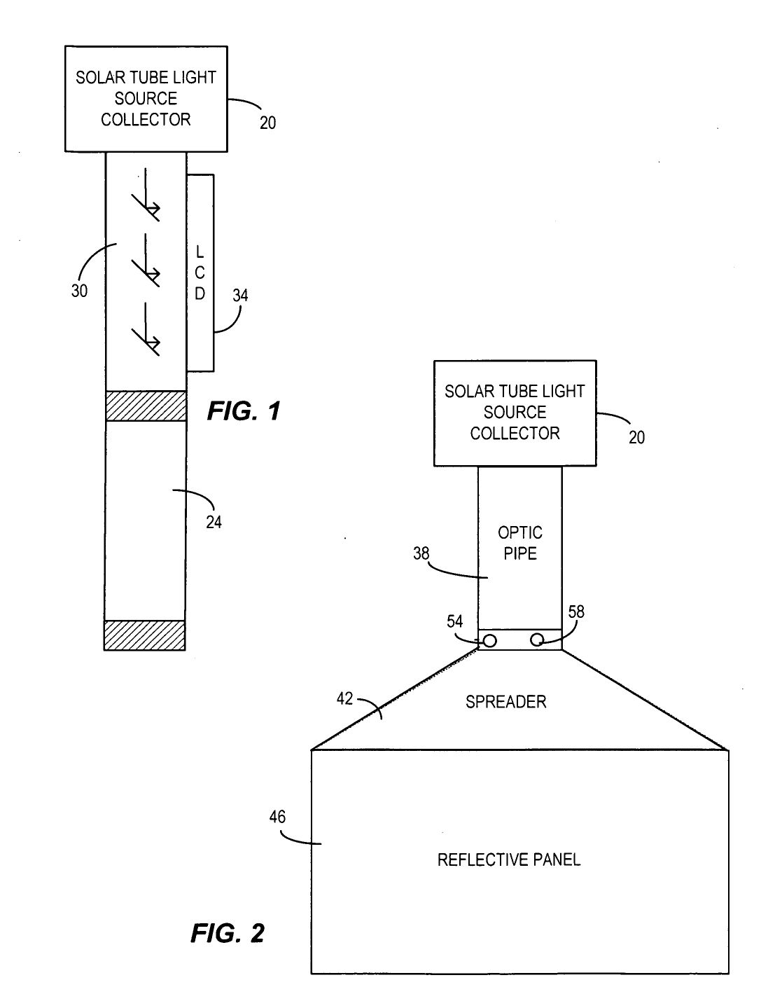

The internal components are further illustrated in FIG. 2. Light collected from collector 20 passes through an optic pipe 38 such as a light tube or fiber (the optic pipe) and is passed into a spreader 42 in order to spread or diffuse the light to produce a relatively even light distribution across the area of the display panel. The spread light is then projected out toward the electronic transmissive display panel in a uniform manner by a reflective panel 46. Those skilled in the art will appreciate that the source of light can be manipulated by lenses, mirrors, diffusers, etc. at any suitable point in the pathway between the collector and the electronic transmissive panel so as to produce a relatively even distribution of light energy across the panel thereby producing an approximately evenly backlit display.

In accord with certain implementations, a sensor 54 near the collector or elsewhere along the light path can be used to evaluate the light quality. This information can be used by control electronics (not shown) for compensation by the display for the amount of available backlight to the display. Factors evaluated might include intensity and color temperature. Gamma and other image characteristics can be adjusted accordingly adjusted to make use of the available light. In addition, a supplementary light source 58 is preferably provided to supplement the ambient light or take the place thereof during times when insufficient ambient light is available to illuminate the display. While elements 54 and 58 are shown situated between the collector and the spreader, other arrangements are possible including provision of distributed light sources along the reflective panel, etc.

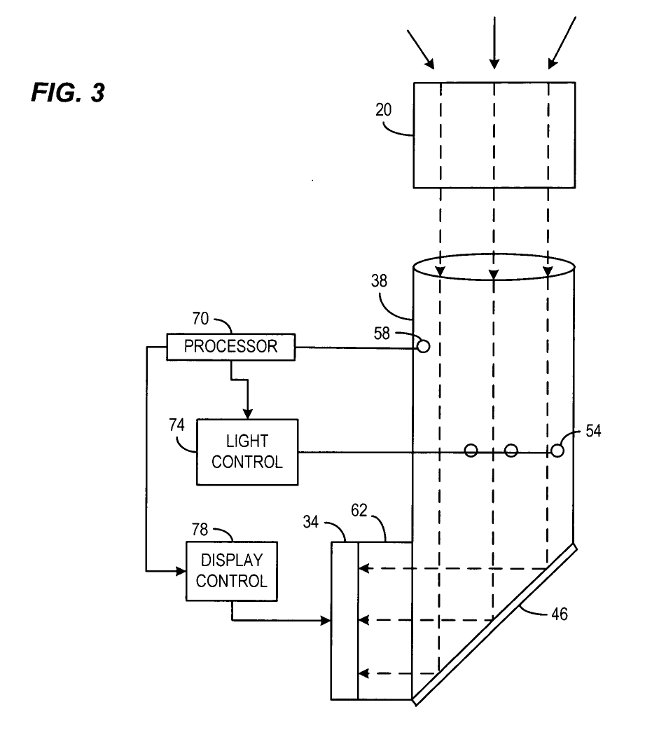

FIG. 3 depicts a similar arrangement from a side view wherein light passes from collector 20 through pipe 38 and is reflected at reflector 46 through a diffuser 62 to illuminate display 34. While a reflector is shown in the embodiments depicted, light could be directly piped into the rear of the display panel without need for reflection, and can instead be directed thereto directly or through a diffusion lens or any of multiple other mechanisms for dispersion of the captured sunlight. The light sensor 58 can detect light intensity, color temperature and other characteristics that can be provided to a processor 70 in order to control the supplemental backlight 58 as needed using a light control 74. Additionally, the light characteristics from processor 70 can provide information for use by the display control 78 to adjust brightness, contrast, gamma and other color correction factors of the display panel 34 to maintain image quality.

In the embodiment depicted in FIG. 1, the light pipe and associated hardware can be installed within a home or business wall structure to both conserve energy by use of solar light sources and to hide the structure from view. However, this should not be considered limiting. Similar structures could be used for outdoor displays where the bright light of the sun completely washes out conventional displays to the human eye. In certain circumstances, it is desirable to use LCDs or other electronic transmissive displays outdoors because they are becoming cost effective. But unfortunately they are not sufficiently bright to overcome ambient light in daytime applications. Night time use is acceptable, but daytime is generally not good because of the intensity of the sun. Night time use alone may not warrant an installation, however. If a cost effective way could be found to brightly illuminate the LCD, then there may be many outside applications where it might be used.

As noted previously, only about five percent of the backlight produced for LCD displays passes through on the panel. Given the limitation of output Etendue the area and the collection angle of the collector can be optimized to provide optimal brightness. In certain implementations, the collector itself can also be used to provide shade for the LCD, further enhancing its visibility. Since only about five percent of the light makes it through the panel, by increasing the collection by a factor of about twenty the display can be made to compete with the ambient light to permit the display to be readily seen by a viewer. In such installations, one concern is that the light energy required to backlight the LCD panel might generate a large amount of heat. Hence, appropriate cooling techniques such as ventilation, cooling, infrared light filtering and/or heat sinking should be implemented in such cases to protect the panel.

Applications for this technology can also be applied not only to home environment indoor displays for active or passive video content (e.g., moving or still images), but also can be used outdoors or in areas that consume large amounts of energy to power displays such as retail stores, warehouse stores, airports, train stations, etc. Those skilled in the art will appreciate other applications upon consideration of the present teachings.

Thus, a backlighted electronic transmissive display assembly consistent with certain implementations has an electronic transmissive display panel that produces a visual display using light passing through the panel. A solar light collector collects sunlight. Light is received from the solar light collector and supplied as a backlight to the electronic transmissive display panel.

In certain embodiments, the light received from the solar collector is reflected using a reflector that reflects the solar light into a back of the electronic transmissive display panel. In certain embodiments, a diffuser takes the received light from the solar collector and produces light having a more even distribution across the electronic transmissive display panel. In certain embodiments, a light spreader spreads the collected light across the electronic transmissive display panel. In certain embodiments, a light pipe that directs the light from the solar light collector toward the rear of the electronic transmissive display panel. In certain embodiments, at least one component of the assembly is disposed and at least partially hidden within a wall. In certain embodiments, a light sensor detects an attribute of the sunlight and makes an electronic adjustment of the display panel in accordance therewith. In certain embodiments, the attribute comprises at least one of light intensity and color temperature. In certain embodiments, one or more processors control a supplemental backlight. In certain embodiments, a display control adjusts a function of the display panel. In certain embodiments, a display control adjusts at least one of brightness, contrast and gamma responsive to the attribute of the sunlight from the light sensor.

Another backlighted electronic transmissive display assembly has an electronic transmissive display panel that produces a visual display using light passing through the panel. A solar light collector collects sunlight. A reflector receives the solar light and reflects the solar light into a back of the electronic transmissive display panel. A light pipe directs the light from the solar light collector to the reflector. A light conditioner spreads or diffuses the collected sunlight prior to application to the display panel.

In certain embodiments, at least one component of the assembly is disposed and at least partially hidden within a wall. In certain embodiments, a light sensor detects an attribute of the sunlight and makes an electronic adjustment of the display panel in accordance therewith. In certain embodiments, the attribute comprises at least one of light intensity and color temperature. In certain embodiments, one or more processors control a supplemental backlight. In certain embodiments, a display control adjusts a function of the display panel. In certain embodiments, a display control adjusts at least one of brightness, contrast and gamma responsive to the attribute of the sunlight from the light sensor.

Another backlighted electronic transmissive display assembly has an electronic transmissive display panel that produces a visual display using light passing through the panel. A solar light collector collects sunlight. A reflector receives the solar light and reflects the solar light into a back of the electronic transmissive display panel. A light pipe directs the light from the solar light collector to the reflector. A light conditioner spreads or diffuses the collected sunlight prior to application to the display panel. A light sensor detects an attribute of the sunlight and makes an electronic adjustment of the display panel in accordance therewith, wherein the attribute is at least one of light intensity and color temperature. A supplemental backlight is provided. One or more processors control the supplemental backlight and adjust at least one of brightness, contrast and gamma responsive to the attribute of the sunlight from the light sensor.

In certain embodiments, at least one component of the assembly is disposed and at least partially hidden within a wall.

Those skilled in the art will recognize, upon consideration of the above teachings, that certain of the above exemplary embodiments are based upon use of a programmed processor such as processor 70. Light control 74 and display control 78 may also embody one or more programmed processors, and the functions of elements 70, 74 and 78 may be carried out in a single or multiple processors without limitation. However, the invention is not limited to such exemplary embodiments, since other embodiments could be implemented using hardware component equivalents such as special purpose hardware and/or dedicated processors or combinations thereof. Similarly, general purpose computers, microprocessor based computers, micro-controllers, optical computers, analog computers, dedicated processors, application specific circuits and/or dedicated hard wired logic may be used to construct alternative equivalent embodiments. The processes carried out are similar to those that would be used to match any light source used as a backlight to a display panel, except that the light source's characteristics are to be considered dynamic and affected by use of supplemental light source with known characteristics, cloud cover, and other environmental characteristics.

While certain illustrative embodiments have been described, it is evident that many alternatives, modifications, permutations and variations will become apparent to those skilled in the art in light of the foregoing description.

What is claimed is:

1. A backlighted electronic transmissive display assembly, comprising:
an electronic transmissive display panel that produces a visual display using light passing through the panel;
a solar light collector that collects sunlight; and
means for receiving light from the solar light collector and supplying the solar light as a backlight to the electronic transmissive display panel.

2. The backlighted electronic transmissive display assembly according to claim 1, wherein the means for receiving light from the solar collector includes a reflector that reflects the solar light into a back of the electronic transmissive display panel.

3. The backlighted electronic transmissive display assembly according to claim 1, wherein the means for receiving light from the solar collector includes a diffuser that takes the received light from the solar collector and produces light having a more even distribution across the electronic transmissive display panel.

4. The backlighted electronic transmissive display assembly according to claim 1, wherein the means for receiving light from the solar collector includes a light spreader that spreads the collected light across the electronic transmissive display panel.

5. The backlighted electronic transmissive display assembly according to claim 1, wherein the means for receiving light from the solar collector includes a light pipe that directs the light from the solar light collector toward the rear of the electronic transmissive display panel.

6. The backlighted electronic transmissive display assembly according to claim 1, wherein at least one component of the assembly is disposed and at least partially hidden within a wall.

7. The backlighted electronic transmissive display assembly according to claim 1, further comprising a light sensor that detects an attribute of the sunlight and makes an electronic adjustment of the display panel in accordance therewith.

8. The backlighted electronic transmissive display assembly according to claim 7, wherein the attribute comprises at least one of light intensity and color temperature.

9. The backlighted electronic transmissive display assembly according to claim 8, further comprising one or more processors that control a supplemental backlight.

10. The backlighted electronic transmissive display assembly according to claim 9, further comprising a display control that adjusts a function of the display panel.

11. The backlighted electronic transmissive display assembly according to claim 9, further comprising a display control that adjusts at least one of brightness, contrast and gamma responsive to the attribute of the sunlight from the light sensor.

12. A backlighted electronic transmissive display assembly, comprising:
an electronic transmissive display panel that produces a visual display using light passing through the panel;
a solar light collector that collects sunlight;
a reflector that receives the solar light and reflects the solar light into a back of the electronic transmissive display panel;
a light pipe that directs the light from the solar light collector to the reflector; and
a light conditioner that spreads or diffuses the collected sunlight prior to application to the display panel.

13. The backlighted electronic transmissive display assembly according to claim 12, wherein at least one component of the assembly is disposed and at least partially hidden within a wall.

14. The backlighted electronic transmissive display assembly according to claim 12, further comprising a light sensor that detects an attribute of the sunlight and makes an electronic adjustment of the display panel in accordance therewith.

15. The backlighted electronic transmissive display assembly according to claim 14, wherein the attribute comprises at least one of light intensity and color temperature.

16. The backlighted electronic transmissive display assembly according to claim 15, further comprising one or more processors that control a supplemental backlight.

17. The backlighted electronic transmissive display assembly according to claim 12, further comprising a display control that adjusts a function of the display panel.

18. The backlighted electronic transmissive display assembly according to claim 12, further comprising a display control that adjusts at least one of brightness, contrast and gamma responsive to the attribute of the sunlight from the light sensor.

19. A backlighted electronic transmissive display assembly, comprising:
an electronic transmissive display panel that produces a visual display using light passing through the panel;
a solar light collector that collects sunlight;
a reflector that receives the solar light and reflects the solar light into a back of the electronic transmissive display panel;
a light pipe that directs the light from the solar light collector to the reflector;
a light conditioner that spreads or diffuses the collected sunlight prior to application to the display panel;
a light sensor that detects an attribute of the sunlight and makes an electronic adjustment of the display panel in accordance therewith, wherein the attribute comprises at least one of light intensity and color temperature;
a supplemental backlight;
one or more processors that control the supplemental backlight and adjust at least one of brightness, contrast and gamma responsive to the attribute of the sunlight from the light sensor.

20. The backlighted electronic transmissive display assembly according to claim 19, wherein at least one component of the assembly is disposed and at least partially hidden within a wall.
